(19) United States
(12) Patent Application Publication
(10) Pub. No.: US 2014/0156413 A1
(43) Pub. Date: Jun. 5, 2014

(54) Synchronized Advertiser Across Multiple eBook Titles

(71) Applicant: Jon D. Cameron, Dallas, TX (US)

(72) Inventor: Jon D. Cameron, Dallas, TX (US)

(73) Assignee: David Dunlap, LLC, Dallas, TX (US)

(21) Appl. No.: 13/785,386

(22) Filed: Mar. 5, 2013

(51) Int. Cl. G06Q 30/02

(52) U.S. Cl. CPC G06Q 30/0264
USPC 705/14.61

(57) ABSTRACT

A method of predetermining the reading schedules of multiple eBooks to be read simultaneously and then applying those schedules to the distribution of advertising so each eBook displays the same advertiser at the same time.

### BACKGROUND

1. Field of Invention

The invention related to the system and method of displaying the same advertiser for simultaneously read electronic book titles.

2. Background of the Invention

The present invention is a useful and novel method for allowing advertisers to display a unified message when the audience is reading more than one eBook at a time.

Electronic books, or eBooks, are non-paper copies of documents distributed to the human reader through electronic means. The eBook can additionally provide advertising which is useful in reducing costs to the audience and augmenting profit margins for sellers. eBooks are also variously referred to as e-books, e-textbooks, e-editions, or digital books.

### Length and Content

Originally, the term eBook referred to book-length works of fiction and non-fiction. Cultural evolution has extended eBooks to include works of any length including reports, reviews, newspapers and periodicals.

eBooks may contain text, static images, internal links, external links, advertising, translations, imbedded sound, pop-ups and video content. However, the vast majority of eBooks distributed today are primarily restricted to text and static image content. This is because publishing houses are limited to basic file formats by the specialized and proprietary hardware capabilities dominating the eReader market. See the Display Devices discussion below.

### Display Devices

The display of eBooks can be accomplished on four distinct hardware devices.

1. Personal Computer. The personal computer, or PC, is the oldest type of device for displaying eBook material. In the 1970s, the Dynabook notebook computer was originally proposed for the purpose of displaying books instead of using a printed version. Today, the personal computer is still heavily used in the distribution and display of eBooks.
2. Mobile Phone. The convenience of the ubiquitous personal mobile phone make them a popular distribution channel for publishers and distributors. Mobile phones are somewhat problematic for consumers because the underlying operating systems may not be able to provide conveniences associated with other eBook devices: full-page display; bright-light reader; font size adjustment; and, touch screen for both page turning and scrolling.
3. Tablet. Personal computers primarily operated by the user's touch are crudely differentiated in the consumer market as “tablets.” Tablets may actually present nearly identical functionality as mobile phones and PCs. Tablets are sometimes also distinguished from mobile phones and PCs by the devices' size. Too large to fit into a clothing pocket, tablets provide a more ideal electronic book screen size than mobile phones. Smaller and lighter than typical PC configurations, the tablets provides portability associated with paper books. However, the lines are blurring against both mobile phones and PCs. Mobile phone screens are growing in size with newer models described as “small tablets.” Comparatively, the introduction of improved processing chips, smaller battery footprints, and high-capacity solid-state storage, PCs are rivaling the weight and size of tablets.

Characteristics of tablets continue to blur as PC-like variations now include physical keyboards, integrated mouse pad, and screen covers.

4. Dedicated eReader. Electronic book readers, variously referred as eBook device, eReader or eBook reader, are the latest hardware forms for reading eBooks. The dedicated eReader is specifically designed to mimic the footprint of a hardbound novel. The eReaders almost exclusive use is for reading of books and periodicals. Modern hardware versions focus on characteristics that improve the reading experience: visibility in bright or direct light; and long battery life. eReaders are typically sold at a loss by digital eBook sellers allowing the sellers to be the exclusive provider of content. eReaders may be able to connect to the internet through various wired or wireless input devices. As eReaders become more connected, manufacturers and 3^{rd} party developers are offering applications typically associated with mobile phones and tablets. Dedicated eReaders have not had the broad market appeal anticipated by early pundits. Instead the limited hardware configuration has been largely ignored by the application-intensive younger consumer. eReader adoption is primarily among consumers age 55+. Ninety percent (90%) of eReader users only use the device for reading books or periodicals. Industry experts believe dedicated eReader hardware could be phased out by tablet adoption.
eBook File Formats

eBooks cannot be distinguished by the file type. Today, the most popular way to distribute electronic books is by using the portable document format, or *.pdf, popular in all forms of document distribution. HTML is also a popular format. However, there are copious numbers of file types used for eBooks and there are many more to be advanced. Other current file types include ArchosReader (*.aeh), Kindle (*.azw), DjVu (*.djvu), Microsoft Word (*.doc*), EPUB (*.epub), EBook (*.exe), Multimedia FictionBook (*.fb2), Microsoft Reader (*.lit), eReader (*.pdb), Mobipocket (*.prc, and *.mobi), PostScript (*.ps), Repligo (*.rgo) and Plain text (*.txt).

Advertising in eBooks

Advertising in paper books has long been an intermittent practice by publishers. The practice thrived from the early 1900s through the 1960s. The '60s brought in more timely and effective advertising tools through television and full-color periodicals. Although outside advertising subsided in subsequent years, publishers still advertise their own products in the front and back of trade paperbacks today. These can be full color or black and white. They may include advertisement for other author's materials or advertisements for the author of the paperback.

The advent of eBooks has re-ignited publisher interest in advertising in books if for no other reason than to supplement their diminished profit margin on eBook formats. eReaders and tablets allow the delivery of timely advertising based on the human reader's profile, location of the eReader, browsing history, purchase history, book content, and other geodemographic material. Delivery can be measured in standardized return-on-investment set of calculations across dozens of data metrics. Essentially, the electronic format eliminates the issues that previously made books unattractive to advertisers.

However, publishers and authors have resisted much of the opportunity eBook advertising represents. Some of this has to do with the culture, and even the antiquated title, of “publishers.” Delivering content electronically eschews the business models, equipment and skill sets long associated with the publishing business.

Similarly, authors have been resistant to the changes eBooks represent to their income. eBooks sell for less than printed books because of consumer impression of reduced printing costs and eliminated middlemen. eBooks are causing large retailers to scale back on the title assortment in all publishing forms. The result is fewer titles are being picked up, advances have decreased dramatically and incomes for authors have similarly declined. eBooks return about half of the author's income compared to paper books.

Author's views of eBook advertising has a direct correlation to their individual success and income. Established authors have resisted any advertising not directly related to their works. The perceived lack of controls over advertising content gives way to concern over the quality of the reading experience. Since authors directly control a book's content, inserting ads in e-books won't happen without author approval. New or low-income authors have more readily adopted advertising as way to supplement their, and the publisher's, income. There are regular seminars on how authors can use advertising to boost income.

The end-users have expressed mixed, but certainly not enthusiastic, response to electronic book advertising. Academics see it as advertisers attempt to co-opting knowledge and culture channels. Consumers find the advertising obtrusive to the reading experience but hesitantly find value in the trade-off between less expensive hardware and eBooks. Online retailers with proprietary electronic readers have offered the eReaders at a lower retail if consumers agreed to allow advertising during power-up, after powering down and while shopping for titles. Perceived as unobtrusive, the ad-supported hardware has become very popular. Notably, this advertising is tied to a specific eBook, but to the hardware. However, the advertising allows the online retailer to take losses on the unit sales. Online retailers are expected to push for market share by moving retail prices of eBook as close to $0.00 as possible in the coming years. There is little doubt the consumer will find the value exchange worthwhile. It would also signal a steep demise to printed books as this “paper penalty” would diminish perceived value of printed books to nearly zero.

As the various electronic formats begin to merge and lose distinction, the lines will blur on what types of eBooks consumers find acceptable formats for advertising (such as e-periodicals) and unacceptable (a novel). eBooks will be begin looking like periodicals and nonfiction e-periodicals will begin looking more like electronic textbooks.

eTextbooks

Electronic education materials, or eTextbooks, are a newer entry into the eBook industry. eTextbooks include student texts, supplemental study material, testing aides, educator manuals, and reference libraries such as dictionaries. eTextbooks are typically content rich and use every type of visual content typically associated with internet web browsers.

eTextbooks were first published with a focus on higher education. The traditional higher education market was characterized by steeper price points and consumers with a high prevalence of devices capable of displaying eBooks. In little time, the possibilities of eTextbooks to enhance and individualize education became apparent to lower educational institutions. Political issues, uniform access to the internet, distribution agreements, and hardware costs have slowed the adoption by lower-education institutions. However, interest remains high as these institutions sort out the issues of digital textbooks.

### Advertising Proliferation

eTextbooks present a new challenge in advertising. The issue can be emotionally charged as educators look for assistance to afford content and hardware, educators attempt to limit advertising exposure to children, author's maintain control of content, and publishers struggle to find an on-going business model for electronic content. Advertisers are looking at any new avenue to reach the children market which represent a half billion in dollars US. About half of that figure is personal spending and the other half is directly-influenced spending.

Despite the heated debates related to advertising proliferation in eTextbooks, advertising has been a part of school textbooks for generations. Early leaders like Walraven obtained patent protection as early as 1925 (U.S. Pat. No. 1,540,297) for the purpose of adding advertising to the outside of the textbook through the use of textbook covers. The advantages of the Walraven book cover solution are similar to the present invention:
1. Textbook covers provided students with limited advertising messages that remained constant across a number of titles;
2. School districts could limit the type of advertisers;
3. School districts could use the proceeds of the advertisers to fund the textbooks themselves;
4. The students were able to interact with the advertising by personalizing the look of the cover;
5. The content of the textbook was undisturbed from the intentions of the authors.

It is clear the continuation of generations of advertising benefits need to be carried into the new electronic format of eTextbooks. It is also clear that meeting these five objectives is important to all the parties involved in eTextbooks. The present invention will revive these benefits into an electronic format.

### Advertisement is Distributing on a Title-by-Title Basis.

Advertising in eBooks and eTextbooks is done by individual titles with no consideration of the collection of titles that are intended to be read simultaneously. The result is a semester's eTextbooks can display dozens of advertising impressions at the same time. This is distracting to the student and objectionable to educators. The advertising in eTextbooks is selected by the publisher and then approved by the author. This arrangement fails to recognize geographic, demographic and psychographic targeting required by modern advertisers and brands.

### No Existing Methodology for a Collection of Titles.

Notably, the current advertising distribution models for eTextbooks are unable to address a comprehensive approach to advertising across a collection of titles. In every case a collection of titles intended to be used simultaneously by students will involve a myriad of uncooperative publishers, distributors, and authors.

### SUMMARY OF THE INVENTION

An invention, which meets the needs stated above, is a system and method to display the same advertiser across multiple eBook titles intended to be read at the same time. This is useful for scheduled reading programs such as curriculum-based programs and book clubs. The result is reduced costs to the audience and/or increased profit margin to the copyright holders.

### OBJECTS AND ADVANTAGES

Accordingly, besides the objects and advantages of eBook advertising system described in the above patent, several objects and advantages of the present invention are:
a) to provide advertisers consistent messaging across multiple titles intended to be read simultaneously;
b) to provide the audience with less ad clutter;
c) to provide publishers with control of ad positioning;
d) to provide educational institutions with control of advertising content;
e) to provide educational institutions with advertising funds to finance the eTextbooks.
f) to provide advertisers with an uncompetitive time for advertising to the audience;
g) to provide similar benefits as the paper textbook covers this patent replaces;
h) to provide all parties with a synchronization of publisher's ad positions, advertiser's content, and syllabus.

Further objects and advantages of this invention will become apparent from a consideration of the drawings and the ensuing description of the drawings.

### DRAWING FIGURES

The accompanying drawings, which are incorporated in and constitute a part of this specification, illustrate embodiments of the present invention and together with the description, serve to explain the principles of this invention. In the figures:

FIG. 1.—Illustration shows two titles of eTextbooks displaying the same advertiser simultaneously.

FIG. 2.—Flow chart depicting the key elements for displaying simultaneous advertising.

FIG. 3A.—Drawing illustrating a syllabus or reading schedule.

FIG. 3B.—Drawing depicting a list of advertisement placement markers.

FIG. 3C.—Drawing depicting a catalog of advertisements.

FIG. 3D.—Drawing illustrating the connection between the reading schedule, catalog, and markers.

### KEY TERMS

Title: An identifying name given to a book, eBook, eTextbook, chapter, textbook, article, blog, report, composition, manual, examination, study materials, dictionary or other work.
eBook: Non-paper copies of documents distributed to the human reader through electronic means. Also called electronic book.
eTextbook: Identical to eBooks but with unique characteristics such as read simultaneously with other titles and generally associated with a distinct syllabus having a begin and end date.
Ad marker: Predetermined space allocated by the publisher, distributor or author for the location of advertising space associated with the eBook. The advertising space can comprise covers, pages, margins, bookmarks, headers and footers.

### REFERENCE NUMERALS IN DRAWINGS

10 eBook, electronic book, electronic document, e-editions, digital books, eTextbook
15 Title
20 eReader, eBook reader, eBook device, device, e-reader
25 eReader display
30 Schedule, time schedule, syllabus, reading schedule
35 Time, date
40 Advertising, advertisement
45 Advertiser
50 Catalog, advertisement catalog
60 Placement data
65 Ad marker, placeholder
70 Advertising Distribution

### DETAILED DESCRIPTION OF THE DRAWINGS

Referring to the drawings, in which like numerals represent like elements,

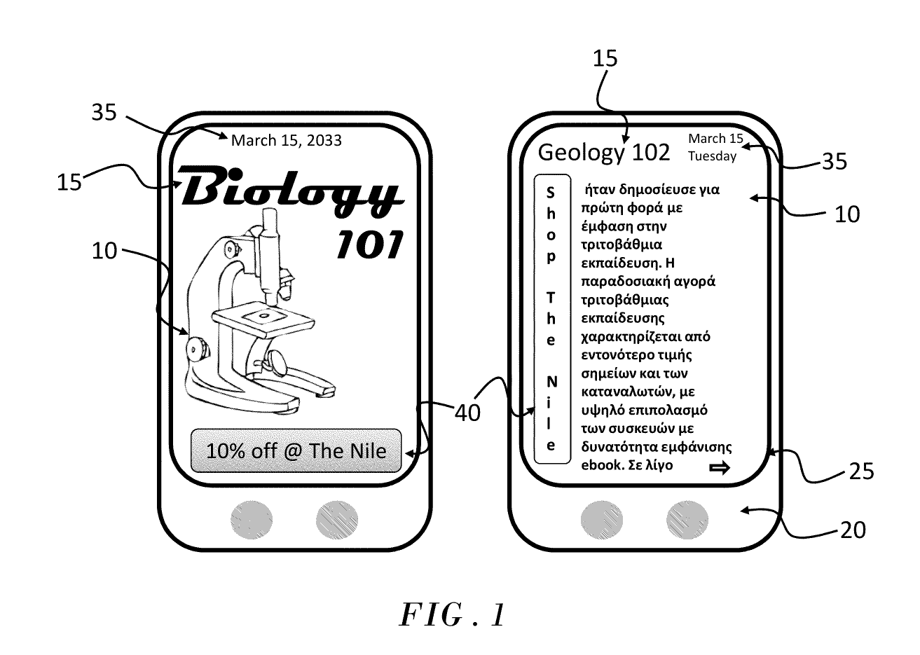

### FIG. 1

First turning to FIG. 1, we see an illustration of two eTextbooks 10 titles 15: “Biology 101” on the left and “Geology 102” on the right. Each eBook 10 is displayed on an eReader 20 hardware which may be the same or different eReaders 30. While the subjects and titles 15 are unrelated, there are similar notable elements. First, we can observe the dates 35 on each eReader display 25 are the same. As we will see in the next diagrams, the date and/or time 35 stored in the schedule 30 dictate the same advertiser 45 will be displayed during the same time 35. In each eReader display an advertisement 40 for the advertiser 45 “The Nile” is displayed for the same date 35 of Tuesday, Mar. 15, 2033.

While the advertiser 45 is the same, the format of the ad 40 may be different because different publishers will have assigned unique place holders 65 based on proprietary copyrights. These placeholders 65 will vary by size and capabilities. For instance, an ad marker may have different characteristics such as dimensions, location on the page, and allowed capabilities. The “Biology 101” title 15 shows an advertisement 40 on the cover page of the eTextbook 10 offering “10% off @ The Nile” and an interactive click-through button. The “Geology 102” title 15 instead shows the advertisement 40 as a margin banner simply reading “Shop The Nile.” So while the specific advertisement 40 is different, the advertiser 45 is the same for the simultaneously read eTextbooks 10.

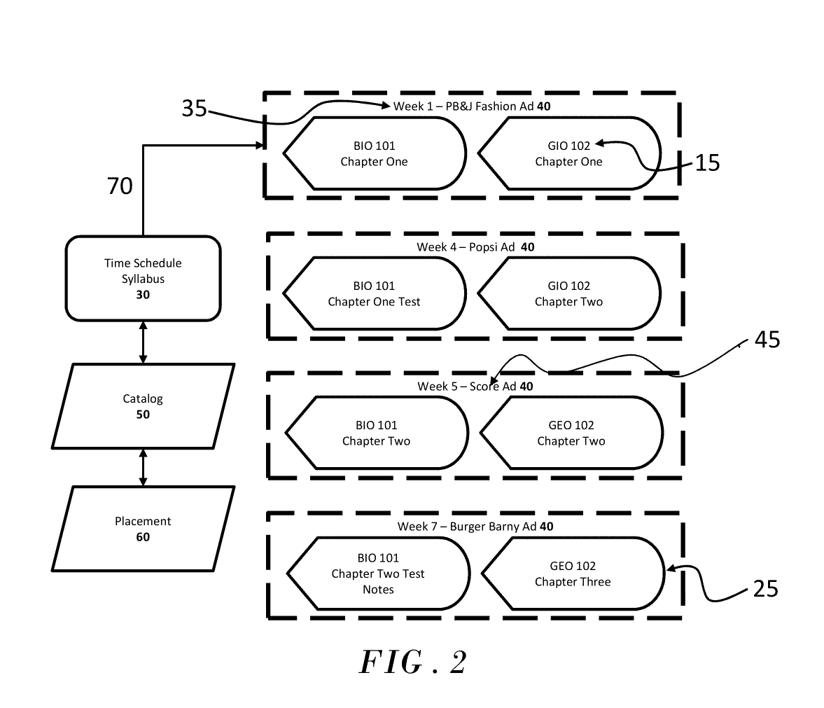

### FIG. 2

Turning now to FIG. 2, the logic flow charts depicts key elements used to display the same advertiser 45 on an eReader display 25 across multiple titles 15. The system comprises three data sets stored as data storage files. Data storage files can be relational databases, flat files, lists, tables, or any electronic means for recording and storing data for later retrieval. The three data files may be stored on separate computers, may be on separate networks, or stored as a single file.

The first data set, called a placement 60 file, is a listing of designated advertising 40 placeholders 65 for an eBook 10 or a group of eBooks 10. These placeholders 65 are assigned by the author or publisher before the release of the eBook. For instance, one publisher may prefer the use of margin banners on the first page of each chapter while another publisher may only permit an interactive 1″×3″ advertisement 40 on the cover page of the eBook 10.

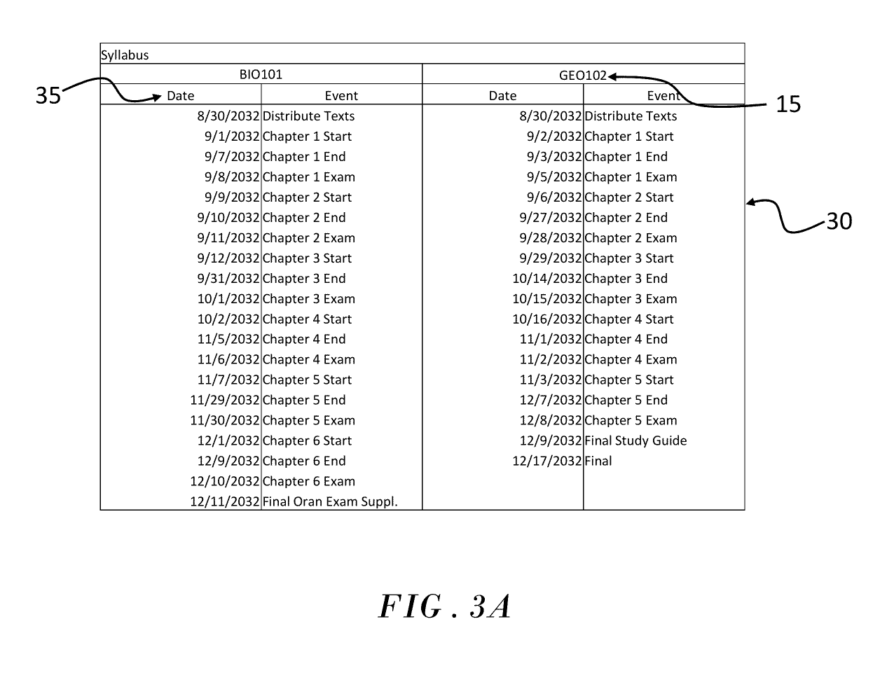

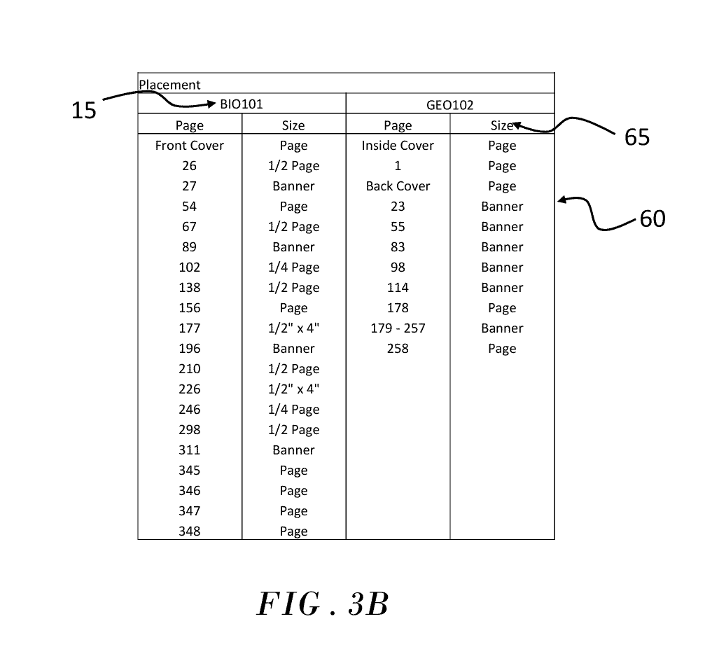

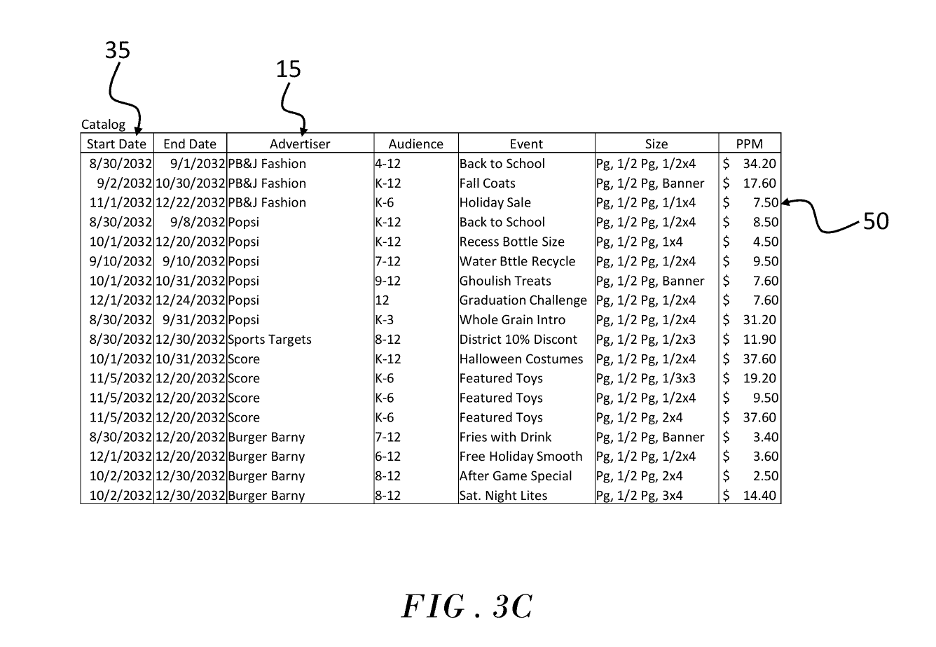

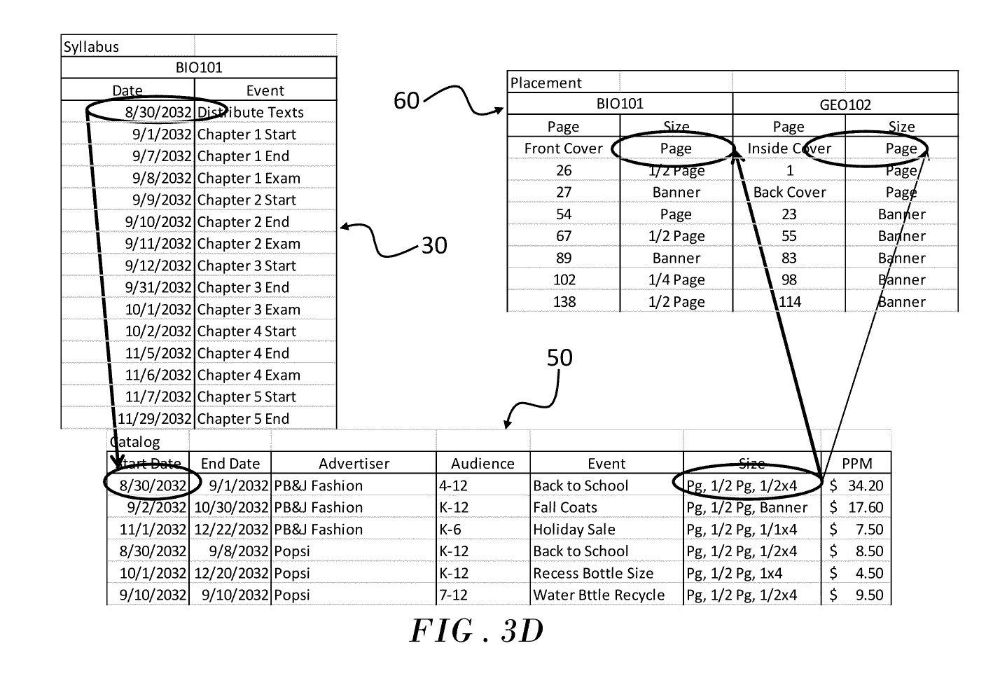

Further detail about these data sets is found in the subsequent discussion of FIGS. 3A through 3D.

The second data file is a listing, or catalog 50, of the advertising 40 available to be placed in placeholders 65 in the eBooks 10. This data file comprises all relevant information to proper placement including multiple size of each advertisement 40, date for distribution, images, demographic targets, and executable files. This data file may be collected by any number of entities including school districts, book clubs, libraries, private book lenders, distributors, sellers and resellers.

The third data file is a time schedule 30 or syllabus 30. This data file comprises a listing of when portions of the eBooks 10 will be used by the audience. At a minimum, the file comprises the dates 35 for reading the title 15, and what portions of the title 15 will be read by the audience. The dates may also include start date 35, end date 35, date 35 of pop quizzes, testing date 35, review date 35, lecture date 35, or completion date 35. This time schedule 30 may be assigned by a club leader, teacher, school system, government organization, etc.

These three data files are combined to tell us what advertising 40 fits in the designated ad markers 65 for a collection of titles 15 so the same advertiser can be simultaneously displayed across the titles 15. The combined files result in advertising distribution 70 to the eBook 10 eReader 20.

In this example FIG. 2, the audience is simultaneously reading two (2) eTextbooks 10 titled 15 “BIO 101” and “GEO 101.” The right of the flow chart shows advertising 40 at specific times 35 in each of the example titles 15.

During the date 35 of Week 1, advertising 40 is scheduled to show the advertiser 45 “PB&J Fashion” in Chapter One of both titles 15. On Week 4, a new advertiser 45 is scheduled to be shown simultaneously in both eTextbooks 10 titles 15. For the title 15 “BIO 101,” the advertiser 45 “Popsi” will be displayed in the test area of Chapter One. For the title 15 “GEO 102,” the “Popsi” advertisement 40 is shown in Chapter Two. So although the progress of each syllabus 30 is uncoordinated, the display of the advertiser 45 is concurrent on the eReader display 25.

Moving through the example, title 15 “BIO 101” shows an advertisement 40 from the advertiser 45 “Score” in the time 35 of Week 5 in the section of Chapter Two. “GEO 102” is still reading Chapter Two, but a new advertisement 40 replaces the “Popsi” advertisement 40 from Week 4 so that the advertiser 45 matches “BIO 101” as “Score.” The advertiser 45 consistency remains the same throughout the entire syllabus 30 of both titles 15. Consequently, in the time 35 of Week 7, the advertiser 45 “Burger Barney” is displayed in both titles 15. For title 15 “BIO 101,” the “Burger Barney” advertisement 40 is located in “Chapter Two Test Notes” while simultaneously in Chapter Three of “GEO 102.”

### FIG. 3A

FIG. 3A depicts an example reading schedule 30 or syllabus 30. This schedule 30 may comprise the title 15, the section of the title 15 to be read by the audience at a particular time 35, start date 35, end date 35, images, links, executables, instructor, educator, mentor, institution, and/or comments. In the example FIG. 3A, the syllabus 30 shows two titles 15 “BIO 101” and GEO 102” with the start date 35 and the reading event scheduled 30 during the time 35. For example, for both titles 15, the students receive their eTextbooks 10 on 8/30/2032 and start Chapter 1 on 9/2/2032. Even though the audience is not anticipated to begin until 9/2/2032, any advertiser 45 who purchased advertising 40 starting on 8/30/2032 and ending before 9/2/2032 would have an advertisement 40 displayed in both titles 15 simultaneously.

### FIG. 3B

FIG. 3B is an illustration of an example advertisement 40 placeholder 65 listing authorized by the publishers for a group of titles 15. This placement data 60 may comprise the title 15, the page within the title 15 were the advertisement 40 placeholder 65 is located, the location of the placeholder 65 on the page, the size of the placeholder 65, restrictions, actions, executables permitted and/or comments. In the present example, the placement data 60 shows two titles “BIO 101” and “GEO 102.” For each title 15, the publisher has listed the page where an ad marker 65 exists and the size of the ad marker 65. For example, “BIO 101” has its first advertising 40 position located on the front cover and the space designated for the advertisement 40 is the entire page.

### FIG. 3C

FIG. 3C depicts an example format of the advertisement 40 catalog 50 within the present invention. The catalog is responsible for containing information about the advertising 40 material available for placement in the ad markers 65 of the titles 15. This catalog 60 may comprise fields such as start date 35 of the advertisement 40, end date 35 of the advertisement 40, approved audience, target audience, name of the event, name of the campaign, the available sizes of the ad 40, the payment rate offered made by the advertiser 45 and/or comments. In the example FIG. 3C, the advertiser 45 “PB&J Fashion” has purchased a “Back to School” advertising 40 starting on the date of 8/30/2032 through 9/1/2032 for the audience of grades 4 through 12. The available sizes for the advertisement 40 include page, half page, and half inch by four inch. The advertiser 45 and has agreed to pay $34.20 for every 1,000 impressions.

### FIG. 3D

Finally, turning to FIG. 3D illustrating the relationship of the reading schedule 30 to the catalog 50 and placement data 60. By tying these pieces together, the present invention is able to effectively deliver the same advertiser 45 to multiple titles 15 simultaneously. Using the same data from FIGS. 3A through 3C, we demonstrate an example of how to link the data sets. While not required of the present invention, this example shows three separate data files linked together through a relational configuration. Relational data files are organized by primary keys and common fields can be linked to create a formal association.

Starting in the upper left corner of the FIG. 3D and working counterclockwise, we start with the time schedule 30 established for reading the eBook 10. In this example, the “BIO 101” eTextbook 10 title 15 is distributed to students on the date 35 8/30/2032 and signals the beginning of the advertising 40 window. Using the date 35 field, we match 8/30/2032 to the catalog 50 of advertisers 45, and find “PB&J Fashion” has an advertising window that matches the date 35. “PB&J Fashion's” “Back to School” event has three different ad sizes: full page, half page, and half inch by 4 inches.

Next we link the event's available sizes in the catalog 50 to the ad size of the markers 65 in the placement data 60. The example shows the publisher has allocated a full page of the front cover of “BIO 101” for advertisement 40. This matches the sizes offered by the advertiser 45 “PB&J Fashion.”

By combining the three data sets, the invention can place an advertisement 40 matching the advertiser's 45 start date 35 and the publisher's available ad marker 65 in the placement data 60 in the titles 15. Since the two titles will simultaneously display the advertiser 45, the “PB&J Fashion” advertiser will also be placed in the “GEO102” using the full page size in the inside cover.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims of the invention. As used herein, the terms “comprises”, “comprising”, or any other variation thereof, are intended to cover a non-exclusive inclusion, such that a process, method, article, or apparatus composed of a list of elements that may include other elements not expressly listed or inherent to such process, method, article, or apparatus.

### ADVANTAGES

From the description above, a number of advantages become evident for the “Synchronized Advertiser Across Multiple eBook Titles.” The present invention provides all new benefits for participating parties including advertisers, publishers, authors, distributors, and consumers, such as:
a) allows consumers greater access to eBook titles while maintaining lower costs per title than traditional paper titles;
b) allows advertisers to limit the number of advertising exposures when the audience is reading more than one scheduled titled simultaneously;
c) allows publishers to balance their need for additional profit margin in eBooks with the wishes of the buyers and audience for lower prices on electronic titles;
d) allows authors to maintain control of their copyright and limit the exposure of advertising to their audience;
e) allows electronic edition distributors to have better access to a broad array of titles including new releases and best sellers;
f) allows publishers to reduce redundancy costs by eliminating the current practice of distributing a printed copy with every eTextbook;
g) allows publishers and authors to have control of the advertising position without the obligation of sourcing the advertising revenue;
h) allows school districts to save costs by not being forced to store printed textbooks force shipped with each copy of a eTextbook;
i) allows educational institutions to use proceeds from the advertisements to fund the titles;
j) allows education institutions to limit the number of advertisers and still meet budget objectives;
k) allows consumers to concurrently read different eBook titles with less distraction from simultaneous exposure by multiple advertisers;
l) Allows various decision makers, such as advertisers, publishers and buyers, to combine input to produce to final advertising output, timing and location within the title.

1. A method for distributing advertising in eBooks comprising: selecting two or more ad markers for two or more eBook titles; selecting the two or more eBook titles for distribution to an electronic reader; selecting two or more advertisements to be displayed in the two or more eBook titles; selecting a schedule of two or more times for display of two or more advertisers; transferring the two or more eBook titles to the electronic reader; transferring the two or more advertisements from the two or more advertisers to the electronic reader; inserting the scheduled advertisements from the identical advertiser into the two or more eBook titles' ad markers;
whereby, the advertising displayed across the multiple eBook titles is of the same advertiser.

2. A method of claim 1, wherein said schedule comprises a date.

3. A method of claim 1, wherein said schedule comprises a time.

4. A method of claim 1, wherein said schedule comprises a syllabus.

5. A method of claim 1, wherein said selecting a schedule of two or more times for display of two or more advertisers comprises a location in the title.

6. A method of claim 1, wherein said inserting the scheduled advertisements comprises inserting advertising of the same advertiser in the ad markers associated with the time from the schedule.

7. A method of claim 1, wherein said inserting the scheduled advertisements comprises inserting advertising of the same advertiser in the ad markers associated with the current time from the schedule.

8. A method of claim 1, wherein said inserting the scheduled advertisements comprises inserting advertising of the same advertiser in all the ad markers of the titles for the time from the schedule.

9. A method of claim 1, wherein said electronic reader comprises more than one reader.

10. A method of claim 1, wherein said advertiser comprises a sponsor.

11. A method for distributing advertising in eBooks comprising: selecting two or more ad markers for two or more eBook titles; selecting the two or more eBook titles for distribution to an electronic reader; selecting two or more advertisements to be displayed in the two or more eBook titles; selecting a schedule of two or more times for display of two or more advertisers; transferring the two or more eBook titles to the electronic reader; transferring the two or more advertisements from the two or more advertisers to the electronic reader; transferring the schedule to the electronic reader; inserting the scheduled advertisements from the identical advertiser into the two or more eBook titles' ad markers;
whereby, the advertising displayed across the multiple eBook titles is of the same advertiser.

12. A method of claim 11, wherein said schedule comprises a date.

13. A method of claim 11, wherein said schedule comprises a time.

14. A method of claim 11, wherein said schedule comprises a syllabus.

15. A method of claim 11, wherein said selecting a schedule of two or more times for display of two or more advertisers comprises a location in the title.

16. A method of claim 11, wherein said inserting the scheduled advertisements comprises inserting advertising of the same advertiser in the ad markers associated with the time from the schedule.

17. A method of claim 11, wherein said inserting the scheduled advertisements comprises inserting advertising of the same advertiser in the ad markers associated with the current time from the schedule.

18. A method of claim 11, wherein said inserting the scheduled advertisements comprises inserting advertising of the same advertiser in all the ad markers of the titles for the time from the schedule.

19. A method of claim 11, wherein said electronic reader comprises more than one reader.

20. A method of claim 11, wherein said advertiser comprises a sponsor.
